(19) United States
(12) Patent Application Publication
(10) Pub. No.: US 2010/0244568 A1
(43) Pub. Date: Sep. 30, 2010

(54) LIGHTING MODULE WITH WIRELESS ALTERNATING CURRENT DETECTION SYSTEM

(75) Inventors: Lance Chandler, Toutle, WA (US); Jim Scalf, Salem, OR (US); Thomas L. Downer, Ocean Park, WA (US); Laurence G. Teeter, JR., Clarksville, TN (US); Thomas T. Teeter, Guthrie, KY (US)

Correspondence Address: Schwabe Williamson & Wyatt;PACWEST CENTER, SUITE 1900, 1211 SW FIFTH AVENUE, PORTLAND, OR, 97204, US

(73) Assignee: Innovative Engineering & Product Development, Inc., Toutle, WA (US)

(21) Appl. No.: 12/415,888

(22) Filed: Mar. 31, 2009

(51) Int. Cl. H02J 7/02; H05B 37/02

(52) U.S. Cl. 307/66; 315/307; 315/149

(57) ABSTRACT

Embodiments of the present disclosure provide methods, systems, and apparatuses related to lighting system with wireless alternating current detection system. Other embodiments may be described and claimed.

### FIELD

Embodiments of the present disclosure relate to the field of lighting, and more particularly, to a lighting system with wireless alternating current detection system.

### BACKGROUND

Auxiliary lighting systems are connected into an electrical network and provide light in the event that a power outage occurs in the electrical network. While these systems provide a critical safety element in emergency situations, their deployment is severely limited by the expense and complexity of wiring them into a structure's electrical network. This is especially the case when these auxiliary lighting systems are added after the structure has been constructed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a lighting module in accordance with embodiments of this disclosure.

FIGS. 2a and 2b respectively illustrate exploded and assembled views of a lighting module in accordance with embodiments of this disclosure.

FIG. 3 is a flowchart describing operation of a lighting module in accordance with embodiments of this disclosure.

### DETAILED DESCRIPTION

In the following detailed description, reference is made to the accompanying drawings which form a part hereof wherein like numerals designate like parts throughout, and in which is shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

Various operations may be described as multiple discrete operations in turn, in a manner that may be helpful in understanding embodiments of the present disclosure; however, the order of description should not be construed to imply that these operations are order dependent.

For the purposes of the present disclosure, the phrase “A and/or B” means “(A), (B), or (A and B).” For the purposes of the present disclosure, the phrase “A, B, and/or C” means “(A), (B), (C), (A and B), (A and C), (B and C), or (A, B and C).”

Various components may be introduced and described in terms of an operation provided by the components. These components may include hardware, software, and/or firmware elements in order to provide the described operations. While some of these components may be shown with a level of specificity, e.g., providing discrete elements in a set arrangement, other embodiments may employ various modifications of elements/arrangements in order to provide the associated operations within the constraints/objectives of a particular embodiment.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

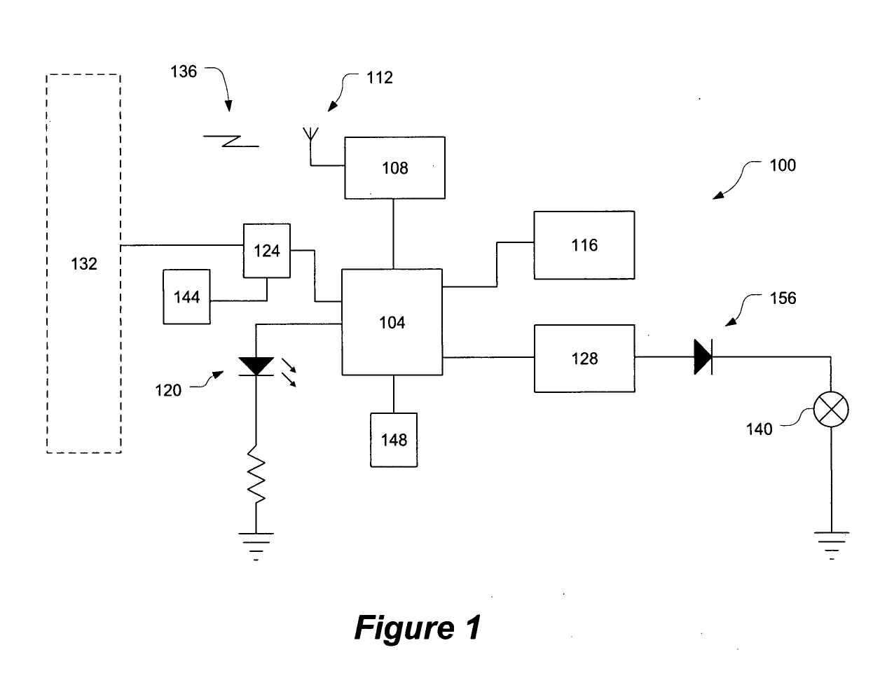

FIG. 1 illustrates a lighting module 100 in accordance with some embodiments of this disclosure. The lighting module 100 may include a controller 104 coupled with a resonant circuit 108, which is, in turn, coupled with antenna 112, as shown. The controller 104 may be further coupled with a programming interface 116, an indicator LED 120, a power supply interface 124, and a power converter 128, as shown.

FIG. 1 also shows an electrical network 132, which may represent a structure's wiring system. Alternating current (AC) power may be present in the electrical network 132 when it, and the larger, external electrical grid to which the electrical network 132 is coupled, is functioning properly. When present, AC power in the electrical network 132 may be alternating at a set operating frequency of, e.g., 60 Hertz (Hz) in the United States or 50 Hz in Europe. The presence of the AC power in the electrical network 132 may result in electromagnetic radiation (EMR) 136 being emitted at the operating frequency. The lighting module 100, when proximally disposed with at least a segment of the electrical network 132, may use the emitted EMR 136 to wirelessly detect a presence or absence of AC power in the electrical network 132 as will be described. As used herein, “proximally disposed” means the lighting module 100 is close enough to at least a portion of the electrical network 132 to reliably receive and detect the EMR 136 when emitted by the electrical network 132.

The antenna 112 may receive EMR, including EMR 136, and the resonant circuit 108 may be tuned to the set operating frequency of the electrical network 132 in order to isolate and detect the EMR 136. In this manner, the resonant circuit 108 may detect a presence of the AC power in the electrical network 132 based at least in part on the antenna 112 receiving the EMR 136 directly from the electrical network 132, i.e., without relying on any intermediate transmitters.

The controller 104 may control an LED 140 based at least in part on a success or failure of the resonant circuit 108 detecting the AC power in the electrical network 132. In some embodiments, the controller 104 may control the LED 140 by activating it when the resonant circuit 108 fails to detect the presence of AC power in the electrical network 132, e.g., when a power outage occurs. Providing the wireless detection of the AC power, as described, allows the lighting module 100 to be flexibly deployed as, e.g., emergency lighting. For example, the lighting module 100 may be deployed at a stairwell to provide emergency illumination in the event of a power outage without having to incur the associated expense of hardwiring an AC outlet for the lighting module 100 to detect an AC power outage.

The power supply interface 124 may couple the lighting module 100 to one or more power supplies to provide power for the various components of the lighting module 100, e.g., the LED 140. The power supply interface 124 may include a first interface to be coupled with a direct current (DC) power source, e.g., a battery 144, and a second interface to be coupled with the electrical network 132. In this embodiment, the controller 104 may provide power to the components of the lighting module 100 from the electrical network 132 when AC power is successfully detected in the electrical network 132 and may provide power to the components of the lighting module 100 from the battery 144 when AC power is failed to be detected in the electrical network 132. Furthermore, if the battery 144 is a rechargeable battery, AC power from the electrical network 132, when present, may be used to recharge the battery 144.

In some embodiments, the controller 104 may control the indicator LED 120 in a manner to indicate whether the lighting module 100 is operating on power supplied by the electrical network 132 or power supplied by the battery 144. In some instances, the controller 104 may activate the indicator LED 120 when the lighting module 100 is operating on power supplied by the battery 144, or vice versa. In other embodiments, the color of the indicator LED 120 may be indicative of whether the lighting module 100 is operating on power supplied by the electrical network 132 or power supplied by the battery 144.

In some embodiments, the lighting module 100 may further include a photodetector 148 coupled to the controller 104. The photodetector 148 may be configured to detect ambient light. In some embodiments, the controller 104 may control the LED 140 based at least further in part on a success or failure of the photodetector 148 detecting ambient light. For example, the controller 104 may use the failure of the photodetector 148 to detect ambient light as a condition precedent to activating the LED 140. This may, in certain situations, prevent the controller 104 from activating the LED 140 if another, adequate source of illumination is present, e.g., sunlight.

The programming interface 116 may provide configurable access to the components of the lighting module 100, e.g., the controller 104, from a programming device. The programming device may configure the controller 104 with respect to any of a variety of control functions, e.g., configuring battery parameters to determine run-time, configuring operating schedules, etc.

In some embodiments, the programming interface 116 may locally couple to the programming device having a user interface that allows local configuration of the lighting module 100. In other embodiments, the programming interface 116 may receive control signals, over a wired network (e.g., a power line network) or a wireless network (e.g., a wireless personal area network or a wireless local area network), from a remote programming device. In the event that the programming interface 116 receives control signals over a wireless network, it may be coupled to an antenna, e.g., antenna 112 or a separate antenna.

In some embodiments, at least a portion of the configuration of the lighting module 100 may be conducted when the lighting module 100 is deployed and the relative disposition of the lighting module 100 and the electrical network 132 is fixed. This may allow the lighting module 100 to be tuned, e.g., through the programming interface 116, to the power/frequency of the EMR 136.

The power converter 128 may be coupled to the power supply interface 124, either directly or through the controller 104, as shown, and the LED 140 and used to provide power to the LED 140 at a desired DC level. Depending on the type of power being provided to the lighting module 100, e.g., AC power from the electrical network or DC power from the battery 144, the power converter 128 may be an AC-DC converter or a DC-DC converter. Both types of converters may be present when both types of power supplies are used. The power provided by the power converter 128 may be conditioned by a diode 156 prior to being supplied to the LED 140.

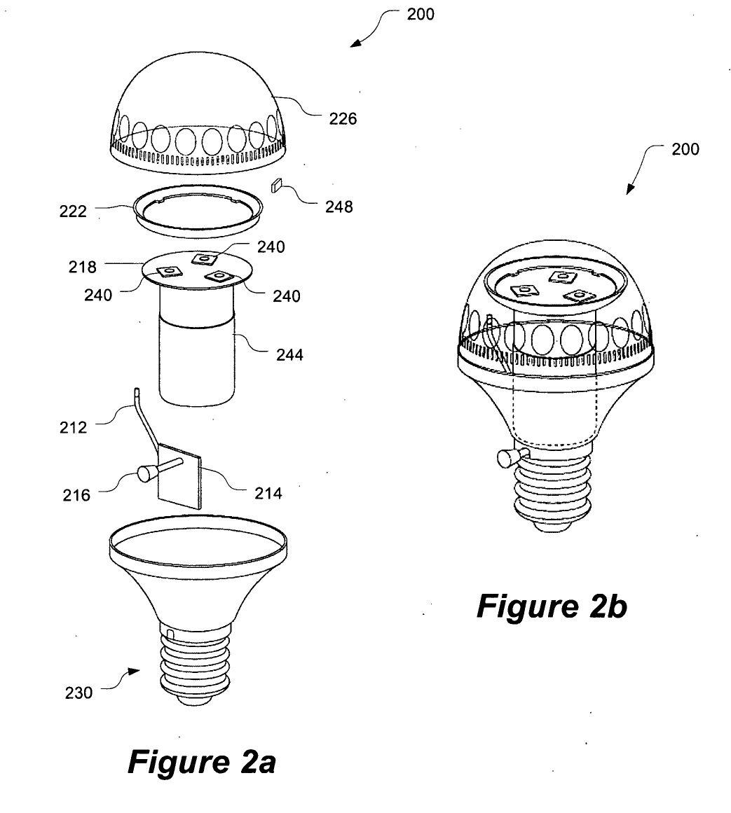

FIGS. 2a and 2b illustrate a lighting module 200 in an exploded view and an assembled view, respectively, in accordance with some embodiments. The lighting module 200 and its components may be similar to, and substantially interchangeable with, the lighting module 100 and its components.

The lighting module 200 may include an antenna 212 coupled to a circuit board 214 that may house and interconnect the various electrical components of the lighting module 200. These electrical components may include components similar to those described above with respect to lighting module 100, e.g., a controller, a power converter, a resonant circuit, etc. The controller, as described above, may control LEDs 240 based at least in part on whether AC power is detected in a proximally-disposed electrical network and/or whether ambient light is detected by a photodetector 248. In this embodiment, three LEDs 240 are shown, however, in other embodiments, other numbers of LEDs may be used.

The circuit board 214 may also be coupled with a state switch 216. The state switch 216 may be operated to change between various operating states of the lighting module 200. For example, in one embodiment the lighting module 200 may have two states. In a first state, the lighting module 200 may function as an emergency light. That is, the LEDs 240 are activated when AC power is not detected in a proximally-disposed electrical network and when ambient light is not detected. In a second state, the LEDs 240 may be activated, regardless of the presence/absence of AC power in the proximally-disposed electrical network and/or ambient light. In this manner, the lighting module 200 may also provide conventional lighting functionality. In other embodiments, additional and/or alternative states may be provided.

One example of a state that may be used in various embodiments is an ambient light sensitivity state. In these embodiments, the state switch 216 may adjust the amount of ambient light that, when present, would prevent the LEDs 240 from being activated when AC power is not detected in a proximally-disposed electrical network. This may allow the lighting module 200 to be further adjusted to the preferences and/or objectives of a particular deployment.

The lighting module 200 may include a mounting board 218 that provides power connections to the LEDs 240 and also couples to a battery 244. A lens reflector 222 may be placed around a perimeter of the mounting board 218 to provide a desired optical effect.

The components of the lighting module 200 may be disposed in a housing that includes a bulb-shaped, light passable body 226 (hereinafter “body 226”) and a base 230. In some embodiments, the base 230 may provide a power supply interface to the electrical network through, e.g., a standard lighting fixture. The base 230 may be an Edison screw base, of any size, as is generally shown. In other embodiments, the base 230 may be any other type of light bulb connector. Furthermore, in some embodiments, the base 230 may function strictly as a mechanical connector and not provide a power supply interface to the electrical network.

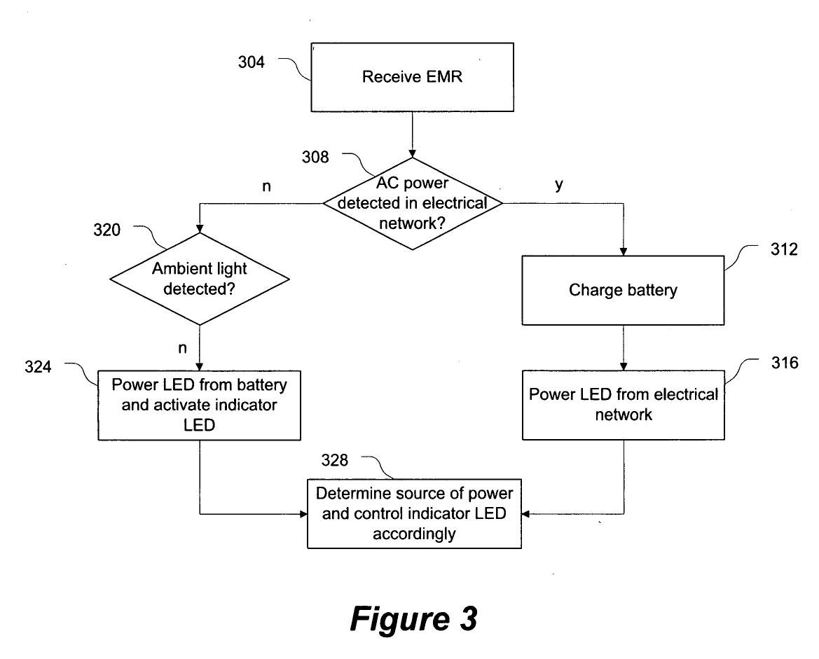

FIG. 3 is a flowchart describing operation of a lighting module, e.g., lighting module 100 and/or lighting module 200, in accordance with some embodiments of this disclosure. At block 304, an antenna of the lighting module may receive EMR. The EMR may be received directly from a proximally-disposed electrical network. At block 308, a resonant circuit of the lighting module may detect for a presence of AC power in a proximally-disposed electrical network based at least in part on EMR of a predetermined frequency being detected. The lighting module may control an LED based at least in part on a success or failure of the resonant circuit detecting the presence of AC power in the proximally-disposed electrical network.

If AC power is detected in the proximally-disposed electrical network, the lighting module may charge a rechargeable battery, at block 312, and power an LED from the electrical network in accordance with an operational state of the lighting module at block 316.

If, at block 308, AC power is not detected in the proximally-disposed electrical network, the lighting module and, in particular, a photodetector of the lighting module, may determine whether ambient light is detected at block 320. The lighting module may then control the LED based at least further in part on success or failure of the photodetector detecting the ambient light. For example, if ambient light is detected, the lighting module may, at block 324, power the LED from a battery.

If the lighting module is equipped with an indicator LED, it may, at block 328, determine whether power is provided to the LED from the electrical network or from the battery and control the indicator LED accordingly. For example, it may activate the indicator LED when power is supplied from a battery and deactivate it when power is supplied from the electrical network.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present disclosure. Similarly, memory devices of the present disclosure may be employed in host devices having other architectures. This application is intended to cover any adaptations or variations of the embodiments discussed herein. Therefore, it is manifestly intended that embodiments in accordance with the present disclosure be limited only by the claims and the equivalents thereof.

What is claimed is:

1. An apparatus comprising:
a light emitting diode (LED);
an antenna configured to receive electromagnetic radiation (EMR);
a resonant circuit coupled to the antenna and configured to detect a presence of alternating current (AC) power in an electrical network having a segment proximally disposed with the apparatus based at least in part on EMR of a predetermined frequency being received by the antenna; and
a controller coupled to the resonant circuit and the LED, and configured to control the LED based at least in part on a success or failure of the detecting by the resonant circuit.

2. The apparatus of claim 1, further comprising:
a photodetector configured to detect ambient light; and
the controller further coupled to the photodetector, and configured to control the LED based at least further in part on the success or failure of the photodetector detecting ambient light.

3. The apparatus of claim 1, further comprising:
a first power supply interface configured to be coupled to the electrical network and the LED;
a second power supply interface configured to be coupled to a battery and the LED; and
the controller configured to provide power to the LED from the first power supply interface when the resonant circuit successfully detects AC power in the electrical network, and to provide power to the LED from the second power supply interface when the resonant circuit fails to detect AC power in the electrical network.

4. The apparatus of claim 3, further comprising:
one or more power converters coupled to the LED and the first power supply interface and/or the second power supply interface, and configured to provide a desired direct current level to the LED.

5. The apparatus of claim 4, further comprising:
another light emitting diode coupled to the controller; and
the controller configured to activate the another LED when power is provided to the LED from the second power supply interface.

6. The apparatus of claim 3, further comprising:
an Edison screw base to provide the first power supply interface.

7. The apparatus of claim 1, further comprising a bulb-shaped light passable body configured to house the LED, the resonant circuit and the controller.

8. The apparatus of claim 1, wherein the antenna receives the EMR directly from the electrical network.

9. A method comprising:
receiving electromagnetic radiation (EMR) at an antenna of a lighting module;
detecting, at resonant circuit of the lighting module, for a presence of alternating current (AC) power in an electrical network having a segment proximally disposed with the lighting module based at least in part on EMR of a predetermined frequency being received by the antenna; and
controlling a light emitting diode (LED) based at least in part on a success or failure of the resonant circuit detecting the presence of AC power in the electrical network.

10. The method of claim 9, further comprising:
detecting, at a photodetector of the lighting module, for ambient light; and
controlling the LED based at least further in part on a success or failure of the photodetector detecting ambient light.

11. The method of claim 9, further comprising:
providing power to the LED from the electrical network when the resonant circuit successfully detects a presence of AC power in the electrical network; and
providing power to the LED from a battery when the resonant circuit fails to detect a presence of AC power in the electrical network.

12. The method of claim 11, further comprising:
determining whether power is provided to the LED from the electrical network or from the battery; and
controlling another LED based at least in part on said determining.

13. The method of claim 9, wherein said receiving comprises:
receiving EMR directly from the electrical network.
